(19) United States
(12) Patent Application Publication
(10) Pub. No.: US 2022/0097023 A1
(43) Pub. Date: Mar. 31, 2022

(54) CONTINUOUS OPEN FOAM POLYMER SHEET METHOD

(71) Applicant: PALZIV EIN HANAZIV AGRICULTURAL COOPERATIVE SOCIETY LTD., Ein Hanatziv (IL)

(72) Inventors: Marvin Langer, Ein Hanatziv (IL); Ehud Nezer, Ein Hanatziv (IL); Benjamin Joshua Reisman, Ein Hanatziv (IL); Scott C. Smith, Osterville, MA (US); Zeev Tzur, Ein Hanatziv (IL); Baruch Zur, Ein Hanatziv (IL)

(73) Assignee: PALZIV EIN HANAZIV AGRICULTURAL COOPERATIVE SOCIETY LTD., Ein Hanatziv (IL)

(21) Appl. No.: 17/423,023

(22) PCT Filed: Jan. 15, 2019
(86) PCT No.: PCT/US19/13648

§ 371 Date: Jul. 14, 2021

(51) Int. Cl. B01J 20/26; B01J 20/04; B01J 20/28; B01J 20/30; C02F 1/28; B09C 1/00

(52) U.S. Cl. CPC B01J 20/267; B01J 20/261; B01J 20/043; B01J 20/045; B01J 20/28045; C02F 2101/32; B01J 20/3064; B01J 20/28085; B01J 20/28011; C02F 1/285; B09C 1/00; B01J 20/3085

(57) ABSTRACT

A polymeric sheet, at least partially cross-linked and/or foamed, having a substantially open cell foam structure is described. A continuous method of manufacturing of an at least partially cross-linked, open cell foamed polymeric sheet is also described.

### CROSS-REFERENCE TO RELATED APPLICATIONS

This application is a 35 U.S.C. § 371 National Stage Application of International Application No. PCT/US19/13648, filed Jan. 15, 2019, the entirety of which is incorporated herein by reference.

### TECHNICAL FIELD

This disclosure is directed to producing open cell foam polymeric products and a method of manufacturing such products. It more particularly refers to such products that comprise cross linked olefin polymers and/or copolymers that have open cell structure.

### BACKGROUND

Conventional open cell foam products can be made by a bun process or by extruding a polymer/blowing agent composition from an extruder die and providing sheet that is typically relatively weak structurally, in part because the open cells are not substantially uniform in cell wall thickness, average cell size, and distribution. For example, if the distribution of blowing agent throughout the molten, pressurized polymer composition is nonhomogeneous, the cells produced are likely to be of uneven size and wall strength (thickness). In addition, prior to the cells are being formed, conditions that enable the cross-linking agent to convert at least a portion of the polymer into a cross-linked material are present that generally results in substantially stronger cell walls as the walls cross-link. Stronger cell walls tend to produce product with more of a closed cell structure.

More particularly, there can be a wide variability in cell structure between the interior portion of a foam sheet product as compared to the cell structure of a surface portion of the sheet (“skin”). Because of this wide variability, it is difficult to make an open cell product that has consistent absorptivity, acoustic properties, compression set and strength, elongation to break, tensile strength, and shear strength, whether by bun processes or continuous processes of combining extrusion with mechanical or physical cell rupture.

In previous attempts to continuously produce open cell foams, depending on pressure drop and amounts of blowing agent present, the cells that are formed can have either an open cell structure; i.e., the cells are interconnected to each other and provide a generally porous product; or the end product may have a closed cell structure; that is, the cells are each independent and isolated from other cells by intact cell walls.

U.S. Pat. No. 8,728,264 discloses a continuous operation of open cell production in which an initial composition of blowing agent, cross-linking agent and polymer sheet are subjected to compression by a series of roller pairs of different gap widths each set at precise temperatures and so to maintain close control over the operating parameters of temperature and pressure to employ a first foaming step and a second foaming step carried out at a different temperature from the first foaming step.

### SUMMARY

In a first example, a method of continuously forming an open cell foam sheet is provided, the method comprising: heating and admixing at least one thermoplastic olefin polymer, at least one foaming agent, and at least one rupturing agent for a period of time sufficient to form a melt suitable for forming a polymer sheet; continuously engaging the polymer sheet under conditions sufficient to at least partially cross-link the polymer sheet so as to provide at least partially cross-linked polymer sheet; continuously engaging the at least partially cross-linked polymer sheet under conditions sufficient to partially decompose the at least one foaming agent and to at least partially foam the partially cross-linked polymer sheet so as to provide an at least partially cross-linked foamed polymer sheet having substantially closed cells; and continuously engaging the at least partially cross-linked foamed polymer sheet through a nip of at least one pair of rollers under conditions sufficient to rupture the closed cells.

In another example, the least one thermoplastic olefin polymer is polyethylene or polyethylene copolymer. In another example, the at least one thermoplastic olefin polymer is ethylene vinyl acetate. In yet another example, the at least one thermoplastic olefin polymer is a mixture of polyethylene or polyethylene copolymer and ethylene vinyl acetate.

In another example, alone or in combination with at least one of the previous examples, the at least one rupturing agent is selected from polymer powder having a melting point higher than the at least one thermoplastic olefin polymer, the rupturing agent present in an amount of between about 10 PHR-50 PHR. In another example, alone or in combination with at least one of the previous examples, the at least one rupturing agent is calcium carbonate or barium sulfate present in an amount of between about 10 PHR-50 PHR. In another example, alone or in combination with at least one of the previous examples, the conditions sufficient to at least partially cross-link the polymer sheet include chemical cross-linking or physical cross-linking.

In a second example, a method to selectively absorb liquid hydrocarbons from a mixture of liquid hydrocarbons and water or land is provided, the method comprising: contacting a mixture of liquid hydrocarbons and water or land with an open cell foam composition comprising the reaction product of: i) at least one thermoplastic olefin polymer selected from polyethylene or polyethylene copolymer, ethylene-alkyl acrylate copolymer, or a mixture thereof; ii) a chemical foaming agent; iii) chemical cross-linking agent or physical cross-linking; and iv) a rupturing agent; where the open-cell foam composition has an absorption weight capacity of hydrocarbon oil of at least about 10 times the weight of the open-cell foam composition.

In another example, the at least one rupturing agent is selected from polymer powder having a melting point higher than the at least one thermoplastic olefin polymer present in an amount of between about 10 PHR-50 PHR. In yet another example, the at least one rupturing agent is calcium carbonate or barium sulfate present in an amount of between about 10 PHR-50 PHR.

In a third example, an open cell foam sheet is provided, the sheet comprising: the reaction product of: i) polyethylene, polyethylene copolymer, or a mixture thereof; ii) a chemical foaming agent; and iii) a chemical cross-linking agent or physical cross-linking; the reaction product comprising an amount of at least one rupturing agent present in an amount of between about 10 PHR-50 PHR capable of facilitating at least 90% closed cell rupturing of the reaction product when subject to compression and/or shear to provide an open-cell foam sheet. In one example, the open-cell foam sheet has an average open cell size of the sheet greater than 0.02 inches (0.5 mm) and less than 0.1 inches (2.5 mm); a density of between about 1.0 and about 3.0 pounds per cubic foot (16 Kg/m³-48 Kg/m³); and an absorption weight capacity of hydrocarbon oil of at least about 10 times the weight of the open-cell foam composition.

In another example, the polyethylene, polyethylene copolymer, or a mixture thereof comprises a linear low density polyethylene and copolymer of ethylene and an alpha-olefin selected from one or more of iso-propene, butene, iso-pentene, hexane, iso-heptene, and octane.

In another example, alone or in combination with at least one of the previous examples, the at least one closed cell rupturing agent is selected from polymer powder having a melting point higher than the polyethylene, polyethylene copolymer, or a mixture thereof. In another example, alone or in combination with at least one of the previous examples, the closed cell rupturing agent is calcium carbonate or barium sulfate present in an amount of between about 10 PHR-50 PHR.

In a fourth example, an open cell foam sheet is provided, the sheet comprising: the reaction product of: i) ethylene-alkyl acrylate copolymer; ii) a chemical foaming agent; and iii) a chemical cross-linking agent or physical cross-linking; the reaction product comprising an amount of at least one rupturing agent present in an amount of between about 10 PHR-50 PHR capable of facilitating at least 90% closed cell rupturing of the reaction product when subject to compression and/or shear to provide an open-cell foam sheet. In one example, the open-cell foam sheet has an average open cell size of the sheet greater than 0.5 and less than 2.5 mm; a density of between about 1.0 and about 3.0 pounds per cubic foot (16 Kg/m³-48 Kg/m³); and an absorption weight capacity of hydrocarbon oil of at least about 10 times the weight of the open-cell foam sheet.

In another example, the ethylene-alkyl acrylate copolymer comprises 20-80 weight percent (wt. %) alkyl acrylate, wherein the alkyl acrylate is selected from one or more of methyl acrylate, ethyl acrylate, and butyl acrylate.

In another example, alone or in combination with at least one of the previous examples, the closed cell rupturing agent is selected from polymer powder having a melting point higher than the ethylene-alkyl acrylate copolymer. In another example, alone or in combination with at least one of the previous examples, the at least one rupturing agent is calcium carbonate or barium sulfate present in an amount of between about 10 PHR-50 PHR.

This disclosure provides means of making open cell foam form sheet materials that are suitable for use in filtration and general fluid absorption activities. Consistent with using such means to produce such open cell foams, it is another object of this disclosure to provide an open cell foam form sheet material having consistent and reproducible porosity and fluid retention capabilities.

This disclosure further provides an open cell sheet form product modified by additives to facilitate cell bursting yet having very consistent cell sizes and cell wall dimensions and strengths.

### BRIEF DESCRIPTION OF THE DRAWINGS

In order to understand and to see how the present disclosure may be carried out in practice, examples will now be described, by way of non-limiting examples only, with reference to the accompanying drawings, in which:

FIG. 1 is a schematic flow diagram illustrating the main steps for performing the process in accordance with the broadest aspect of the present disclosure.

FIGS. 2A-2D are schematic flow diagrams illustrating alternative, more specific steps of the process disclosed in FIG. 1.

FIG. 3 is a schematic continuous open cell foam sheet production process in accordance with the broadest aspect of the present disclosure.

FIG. 4 is a schematic continuous open cell foam sheet production process in accordance with the broadest aspect of the present disclosure.

### DETAILED DESCRIPTION

A foam form sheet material having a first large surface comprising substantially only closed cells and an opposite large surface and an interior comprising substantially only open cells. This material comprises a cross linked olefin thermoplastic polymer or copolymer. The foam is made by mixing the polymer with a blowing agent and a cross linking agent. The mixture is extruded and maintained in a series of heating modules for a time sufficient to initiate cross linking and to initiate foaming to form closed cells. The sheet material is then disposed in a roll mill means having a nip that is smaller than the thickness of the foamed sheet material sufficient to rupture the closed cells to form open cells.

As used in the specification and claims, the forms “a”, “an” and “the” include singular as well as plural references unless the context clearly dictates otherwise.

As used herein, the term “or” means one or a combination of two or more of the listed choices.

Further, all numerical values, e.g., concentration or parts per hundred parts resin (PHR) or ranges thereof, are approximations which are varied (+) or (−) by up to 20%, at times by up to 10%, from the stated values. It is to be understood, even if not always explicitly stated that all numerical designations are preceded by the term “about”. It also is to be understood, although not always explicitly stated, that the reagents described herein are merely exemplary.

The terms “base polymer” and “base resin” are used herein interchangeably and are inclusive of the major component (by weight) of the resultant foamed polymer sheet. In one example, base polymer is a thermoplastic. In one example, the base polymer can comprise at least one polyolefin thermoplastic. As appreciated by those versed in chemistry, “polyolefins” are a class of organic substances prepared by the addition polymerization of alkene (hydrocarbons containing at least one carbon-carbon double bond per molecule), especially ethylene and a lesser amount of propylene, butylene, pentene, hexene, heptane, octene and their respective isomers. The base polymer of the present disclosure can be a blend of one or more polyolefin thermoplastics, and the one or more polyolefins may be combined with one or more other polymers.

The polyolefin may be a homopolymer or a copolymer of ethylene and any C3 to C20 olefin. In accordance with one embodiment, the polyolefin is a copolymer of ethylene and an alpha-olefin selected from of iso-propene, butene, iso-pentene, hexane, iso-heptene and octane. An example of such a copolymer includes, e.g., a metallocene polyolefin, such as ENGAGE™ (DowDupont) EXACT (ExxonMobil US) QUEO (Borealis).

In accordance with one embodiment disclosed herein, the base polymer is extruded as a sheet and at least partially cross-linked and foamed. The base polymer, in its melt form prior to being chemically cross-linked with the same or another polymer, is between 0.3 and 20 melt index, for example, between 0.7 and 5 melt index. Other melt index ranges can be used suitable for the polymer chosen.

There are a variety of polyolefins which exhibit the above melt index and thus may be used to form the polymeric foam disclosed herein. A non-limiting list of possible polyolefins comprises high density polyethylene (HDPE), Medium density PE (MDPE), low density PE (LDPE), linear low density PE (LLDPE), Metallocene PE, poly-1,2-butadiene, ethylene-propylene-diene-rubber (EPDM), thermoplastic rubber, ethylene propylene copolymer, ethylene butlyene copolymer, ethylene vinyl acetate (EVA) polymers, copolymers of ethylene with up to 45% of methyl, ethyl, propyl or butyl acrylates or methacrylates, chlorinated products of the above homopolymers or copolymers having chlorine content of up to 60% by weight and mixtures of two or more of the above mentioned polymers.

Polyolefins for chemical cross-linking to form polymeric foams are readily available in the market. For example, polyolefins may be purchased from Carmel Olefins, ExxonMobil, Borealis, Dow, Dupont, Equistar, Mitsui Chemicals, Sabic etc.

According to one preferred embodiment, the at least one polyolefin is LDPE with a melt index of 0.7-4.

The term “cross-linked” in the context of the present disclosure is used to denote that the polymer chains are inter-connected by a plurality of covalent bonds and that the covalent bonds are stable mechanically and thermally. The term cross-linked encompasses the phrase “chemically cross-linked, or chemical cross-linking,” for example, using a chemical cross-linking agent such as a peroxide cross-linking agent or an azo cross-linking agent, or silane-cross-linking agent, as well as “physical cross-linked or physical cross-linking,” for example, using physical cross-linking means such as high-energy cross-linking (e.g., e-beam, gamma, UV). The extent of such cross-linking can be determined with conventional methods, such as solvent swelling. In one aspect, the extent of cross-linking of the presently disclosed open cell foam sheet is about 50 to about 90% as measured by solvent swelling techniques. The extent of cross-linking can be targeted to achieve a desired foam density and/or foam cell size and distribution as well as control absorption parameters for the foam sheet.

The term “blowing agent” is known in the art and refers to any substance which alone or in combination with other substances is capable of producing a cellular structure in a polymeric or other material. Blowing agents may include compressed gases that expand when pressure is released, soluble solids that leave pores when leached out, liquids that develop cells when they change to gases, and chemical agents that decompose or react under the influence of heat to form a gas. Chemical blowing agents range from simple salts such as ammonium or sodium bicarbonate to complex nitrogen releasing agents. Blowing agents can be endothermic or exothermic.

The phrase “rupturing agent” as used herein is inclusive of certain inorganic minerals, polymer powder additives possessing higher melting points than the base polymer used, and combinations thereof. Examples of inorganic mineral rupturing agents include calcium carbonate, barium sulfate, clay minerals, for example hydrated magnesium silicate (talc), sodium chloride, etc. Examples of polymer powder additives or polymer powders derived from polymers that do not substantially melt during the mixing, cross-linking, and foaming process used for the base polymer. Polymer powder rupturing agents can be used that may undergo partial melting during the foaming processing temperatures and that can contribute to cell rupture during the foaming process, however, it is understood that the addition of an amount of rupturing agent is desired for assisting rupturing after the polymer sheet has been cross-linked, foamed, and reduced in temperature from the foaming process. The majority of the rupturing agent stays distributed or dispersed in the base resin and is present in the cell walls providing weak points therein that assist with rupturing during the crushing/shearing process disclosed herein. Non-limiting examples of polymer powder rupturing agents include polypropylene, polycarbonate, polyester, ultra-high molecular weight polyethylene (UHMWPE) and combinations thereof. The rupturing agents can be virgin or recycled polymer powder that is ground to an average particle size of approximately 1-500 microns.

The continuous open cell foam sheet disclosed herein has the advantage that it may be produced as a continuous sheet, without exhibiting defects and/or functional variation typically encountered when attempting to manufacture continuous sheets of open cell polymeric materials. The polymeric sheet is producible at a thickness of between 2 mm-20 mm and at any length above 2 m. In one aspect, the cell foam sheet is at least partially cross-linked and then foamed to provide a closed cell polymer sheet. In combination with one or more of cross-linking and foaming, the foamed polymeric sheet is subject to bursting where the cells of the foamed polymeric material are ruptured to produce an open celled foamed sheet.

The polymeric foam according to the present disclosure comprises open-cell polymeric foam. The phrase “open cell”, in contrast to “closed cell”, is known to a skilled person and means that essentially all cell walls of the foam are ruptured. For example, open cell foam means at least 90% of the cells have ruptured cell walls, at least 95%, or more than 98%.

In accordance with an embodiment of the disclosure, the open cell's average diameter is between about 50 micron and about 5000 micron, for example, between about 350 micron and about 3500 micron, or between about 500 micron and about 2500 micron.

In addition to the above-mentioned characteristics, the continuous open cell foam sheet disclosed herein may be characterized by one or more of the following properties:
it has a compression set under constant force in air of less than about 50% measured after 24 hrs;
it has a tensile strength of at least 14.5 p.s.i. (100 Kpa);
it has an elongation at break above 30%;
it has a compressive stress (deflection at 25%) of below 2.2 p.s.i. (15 Kpa); and/or
it has a compressive stress (deflection at 50%) of less than 4 p.s.i. (30 Kpa).

The polymeric composition used to form the continuous open cell foam sheet disclosed herein can comprise additives typically used in polymer industry. Such additives can include, without being limited thereto, one or more of a dye, such as a color masterbatch; a softener such as waxes or oils; an antioxidant such as BHT; an anti-fungal such as silver nanoparticles; an anti-static such as GMS; ultra violet resistant additives; an organic filler, such as corn starch or cellulosic material; a co-activator of the chemical blowing agent (catalyst or activator of the foaming agents to lower decomposition temperatures) such as zinc oxide; a conducting agent, such as conductive carbon black, a halogenated flame retardant agent, such as dibromodiphenyl ether or a non-halogenated flame retardant such as magnesium hydroxide, a silanol condensation catalyst, chemical (ECOPURE™ Bio-Tec Environmental, Cedar Crest, N. Mex.; RESTORE™ Enso Plastics, Mesa, Ariz.) or biological agents to facilitate biodegradation of the foam, etc.

The continuous open cell foam sheet disclosed herein can have various applications as discussed above. In accordance with one embodiment, the continuous open cell foam sheet disclosed herein is used as an absorbent. In addition, the sheet disclosed herein can also be used for acoustic and heat insulation panels in automotive applications, fashion accessories (bags, belts etc.), anti-fatigue mats, office notice boards etc.

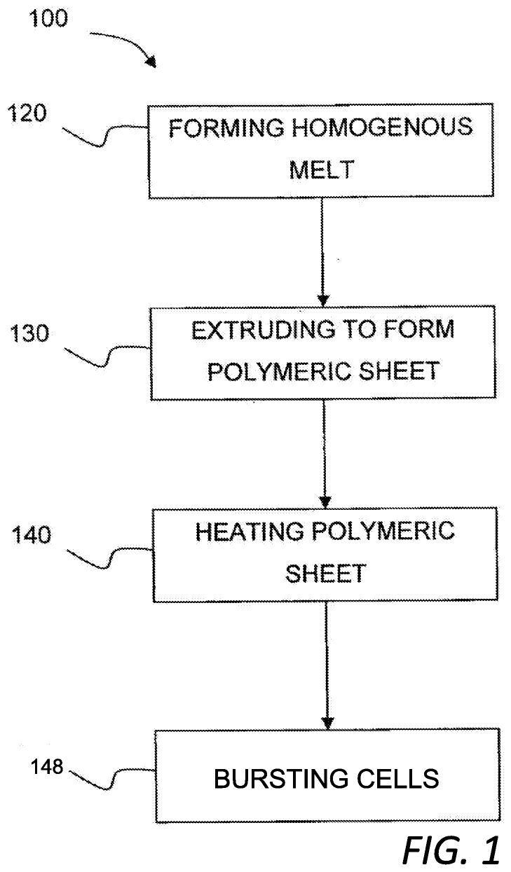

Reference is now made to FIG. 1 which provides a schematic block diagram 100 of the main steps for manufacturing a continuous open cell polymer sheet. It is noted that while FIG. 1 is described as a step-wise process, the process is not a batch process, but rather a continuous process, where each step is continuously operated, thereby allowing the formation of a continuous sheet. In one aspect, the entire process is continuous, including the cell rupturing. In another aspect, the cell rupturing can be performed as a separate process as disclosed and described herein.

Firstly, in Step 120 starting (raw) materials comprising at least one base polymer, at least one cross-linking agent, at least one blowing agent, and at least one rupturing agent are continuously fed into a mixing arrangement set at a temperature of between 60° C. (140° F.) and 200° C. (392° F.) to form a homogeneous molten blend (at times referred to by the term “homogenous melt”).

In Step 120 the raw materials are mixed at a temperature of between about 60° C. (140° F.). and about 200° C. (392° F.) and more specifically, from about 80° C. (176° F.) to about 150° C. (302° F.), so as to allow the formation of a molten blend in which the various constituents are homogenously dispersed in the blend.

The homogenous melt may be obtained by using a variety of mixers known in the polymer industry. Some exemplary, non-limiting mixers include a Banbury mixer, a dispersion mixer, a batch mixer, an internal Mixer, a kneader and others. As appreciated by those versed in the art, mixing in the mixer may take from about several seconds to about several minutes until the homogenous molten blend is obtained.

Once ready, the homogenous melt obtained from Step 120 is transferred, in Step 130, via, e.g. a feed hopper, into an extrusion line.

The homogenous melt is fed into an extrusion line (Step 130) constructed to form from the homogenous melt a continuous polymeric sheet. A typical extrusion line may consist of the raw material feed hopper, a single extruder or a combination of extruders connected in a series, an extrusion die, a calibration unit, and haul-off. The extruders typically comprise a heated barrel containing therein a single or plurality of rotating screws. The extrusion line may include a single extruder or combinations of extruders which may be any one of the extruders known in the polymer industry, including, without being limited thereto, single screw extruder, tapered twin extruder, tapered twin single extruder, twin screw extruder, multi-screw extruder. The extrusion line may also comprise a sheet pre-forming machine. The melt moves from the back of the screw to the head of extrusion die channel in which the melt is simultaneously heated, mixed and pressurized to take up an approximate shape of a sheet.

As appreciated by those versed in the art, the extruder or series of extruders has the following basic functions: it compresses the melt while at the same time allowing removal of volatile gases (optionally removed by vacuum), it softens the melt by heating it (both from internally generated shear forces and additional externally applied heat, if used), it mixes the melt and produces a homogenous melt without impurities, it meters the melt into the die area, and it applies a constant pressure required to force the melt through the die.

The die may be any type of die known in the art, including, without being limited thereto, T-die, strand die, Flat die/Coathanger die etc. The die output may then be transferred into one or more calender rolls for smoothing the surface of the polymeric sheet and/or pressing it to obtain a substantially predetermined uniform thickness throughout the polymeric sheet. In one aspect, as long as the melt is continuously fed from the hopper into the extruder, a continuous sheet of a uniform thickness exits the extruder and can be subsequently fed to a calender, as described above, to obtain a substantially predetermined uniform thickness throughout the polymeric sheet. Calendering rolls can be employed to increase/decrease the width of the sheet and/or precisely control the thickness of the sheet. One or more calendering operations can be performed throughout the process as desired.

The continuous polymeric sheet is then transferred into one or more heating modules (Step 140) for heating the continuous sheet to at least a first temperature at which cross-linking of the at least one polyolefin resin can be performed, albeit being lower than the temperature required for activating the blowing agent.

Step 140 also comprises elevating the temperature within at least one second heating module or in one or more separate ovens, thereby further heating the polymer sheet (or cross-linked sheet) to at least a second temperature at which the blowing agent present in the melt can be activated. In at least one aspect, a at least partially cross-linked, continuous foamed polymeric sheet is obtained.

Step 148 provides for the continuous polymeric sheet of to be ruptured, e.g., to break, fracture, crack, rip, tear, and/or puncture the cell wall between individual cells in on one or both longitudinal or crosswise directions. In one aspect, rupturing is performed on the at least partially cross-linked, foamed polymeric sheet. Additional process steps can be performed, such as rolling the continuous sheet, cutting a predetermined length from the continuous sheet, lamination and/or storage (not shown). Alternatively, the rupturing can be done after the cross-linked, foamed sheet is fabricated, for example, by cooling then storing the product provided after Step 140 and then dispensing the product for bursting as in Step 148.

The cross-linking/blowing heating modules can comprises a conveyer oven adapted to heat the continuous sheet to a number of set temperatures. According to one embodiment, the conveyer oven is a horizontal oven typically of a length of 10-50 m, however, other lengths can be used. The oven is equipped with a moving belt (e.g. stainless steel mesh belt) which slowly transports the sheet at a temperature range which induces either cross-linking or blowing or both (in two distinct sections). According to one embodiment, the temperature range (the first temperature) is between about 70° C. (158° F.) and about 160° C. (320° F.) so as to activate and induce cross-linking. It is noted that the oven can have a fixed temperature or a temperature gradient. The belt transports the sheet at a speed that is variable and is determined upon by the density and thickness of the foam to be produced.

A variety of cross-linking agents may be included in the melt, so as to allow cross-linking of the at least one polyolefin in the melt. Typically used to this end are peroxides (compounds containing an oxygen-oxygen single bond). A non-limiting list of peroxide-based cross-linking agents comprises dicumyl peroxide, di-t-butyl peroxide, 2,5-dimethyl-2,5-di(t-butylperoxy)hexane, 2,5-dimethyl-2,5-di(t-butylperoxy)hexyne-3,1,3-bis(t-butylperoxyisopropyl)benzene, 1,1-bis(t-butylperoxy)-3,3,5-trimethylcyclohexane, n-butyl-4,4-bis(t-butylperoxy)valerate, benzoyl peroxide, p-chlorobenzoyl peroxide, 2,4-dichlorobenzoyl peroxide, t-butyl peroxybenzoate, t-butyl perbenzoate, t-butyl peroxyisopropyl carbonate, diacetyl peroxide, lauroyl peroxide and t-butyl cumyl peroxide.

In one aspect, a peroxide based cross-linking agent in accordance with the present disclosure is dicumyl peroxide.

The cross-linking agent may also be an organosilane linker and a silanol condensation catalyst. For example, the one step “Monosil” process can be used, or alternatively, the two step “Sioplas” technology can be employed. For those knowledgeable in the art, either method can be utilized to produce silane-cross-linked polyolefinic foams.

The blowing heating module, e.g., for creating the voids/cells in the polymer, can constitute a second conveyer oven or a second portion of the conveyer in which cross-linking has occurred. The blowing module is adapted to continuously receive and to heat the sheet (cross-linked or non-cross-linked) to a second temperature capable of activating the blowing agent. The second temperature is typically higher than that required for cross-linking so as to avoid foaming during the cross-linking process. Typically, the second temperature, according to one embodiment, is between about 150° C. (302° F.) and 250° C. (482° F.).

The blowing agent in one aspect is a chemical blowing agent. A non-limiting list of chemical blowing agents comprise azodicarbonamide, barium azodicarboxylate, azobisisobutyronitrile, and azodicarboxylic amide, nitroso compounds, such as N,N′-dinitrosopentamethylenetetramine, N,N′-dimethyl-N,N′-dinitrosoterephthalamide, and trinitrotrimethyltriamine, hydrazide compounds, such as 4,4′-oxybis(benzenesulfonylhydrazide), paratoluenesulfonylhydrazide, diphenylsulfone-3,3′-disulfonylhydrazide, and allylbis(sulfonylhydrazide), semicarbazide compounds, such as p-toluilenesulfonylsemicarbazide, and 4,4′-oxybis(benzenesulfonylsemicarbazide), alkane fluorides, such as trichloromonofluoromethane, and dichloromonofluoromethane, and triazole compounds, such as 5-morpholyl-1,2,3,4-thiatriazole. In one aspect, the blowing agent in accordance with the present disclosure is azodicarbonamide.

It is to be appreciated by those versed in the art that the cross-linking and blowing may take place in two different conveyer ovens, or in a single conveyer oven having one or more sections being heated to one or more temperature where cross-linking takes place, either as a fixed temperature or as a gradient, and one or more second sections receiving the at least partially cross-linked polymer, and having one or more second temperatures, either as a fixed temperature or as a gradient, where the blowing agent is activated and foaming of the at least partially cross-linked sheet takes place.

The temperatures in the two or more different ovens or in the two or more sections of a single oven and the transport velocity of the transporting belts are adjusted, so that the cross-liking process is brought to a predetermined level (e.g., completely or at least partially) before the blowing process takes place.

According to one embodiment, the cross-linking temperatures are in the region of 120° C.-150° C. (248-302° F.). During the cross-linking stage, the polymer sheet is softened, cross-linking takes place, and the melt strength goes up enough so that when, towards the end of the oven (or the first section of the oven), the temperatures can be raised up to a predetermined temperature capable of activating the blowing agent or providing a material that can be foamed. The predetermined temperature of the second oven or second section are typically greater than that of the first oven or first section. In one aspect, the predetermined temperature of the second oven or second section is over 200° C. (392° F.) (for example, in the range of 220° C.-250° C. (428-482° F.). At this temperature the foaming occurs and the sheet material comes out of the oven as a foam sheet.

In one aspect, after formation of the foam (e.g., after foaming is at least partially completed) the continuous sheet can be cooled by one or more chiller rolls prior to take up by one or more rupturing rolls. Rupturing is carried out to provide open cell foam structure.

Rupturing may be carried out by stamping, crushing, or using pinch rolls, the rolls having features of predetermined height, width, length, and spatial arrangement (nip). The rupturing rolls can be heated or chilled. Additional rolls and arrangement of rollers (e.g. serpentine, etc.) can be employed, for example, two or more identically configured (speed, diameter, nip, etc.) rolls, or two or more rolls of varying roll speed and/or varying (stepwise or gradual) nip gap, as can be determined for the particular polymer used, level of cross-linking, amount of blowing agent, and targeted absorption properties.

In one aspect, before or after rupturing a release layer for improving the release of the sheet from the take up roll can be added. The sheet or the at least partially cross-linked, foamed, or at least partially cross-linked and foamed sheet can include a release layer on one or more surfaces.

Before or after rupturing, the sheet can be processed for storage (e.g. rolling, cutting etc.). The continuous rolled sheet can be aged for a sufficient period of time for optimal annealing and relaxation before performing rupturing or other further processing as further described herein with reference to the different applications of the continuous rolled sheet. It is noted that instead of rolling, the continuous polymeric foamed sheet exiting the conveying oven may be cooled and sliced crosswise or lengthwise into reduced thickness sheets (or rolls) of fixed or unlimited length for storage.

A variety of combinations of raw materials may be used to form the continuous sheet of open cell polymeric sheet in accordance with the present disclosure. In an exemplary embodiment, a continuous sheet of at least partially cross-linked foamed polymer is prepared using materials comprising a mixture of at least one polyolefin resin, 0.2-30 PHR, for example, 2-30, 5-30, 10-30, 15-30, or 20-30 PHR of chemical blowing agent blowing agent, 0.1-2 PHR or 0.4-1.2 PHR of a cross-linking agent, 10-100 PHR of rupturing agent, and 0-3 PHR or 0.1-1 PHR of a dye (or color Masterbatch).

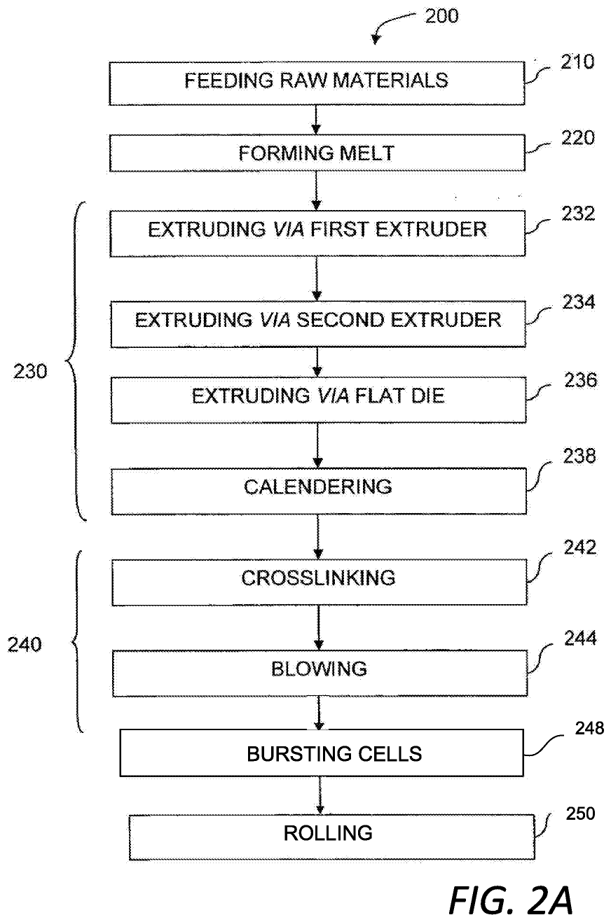

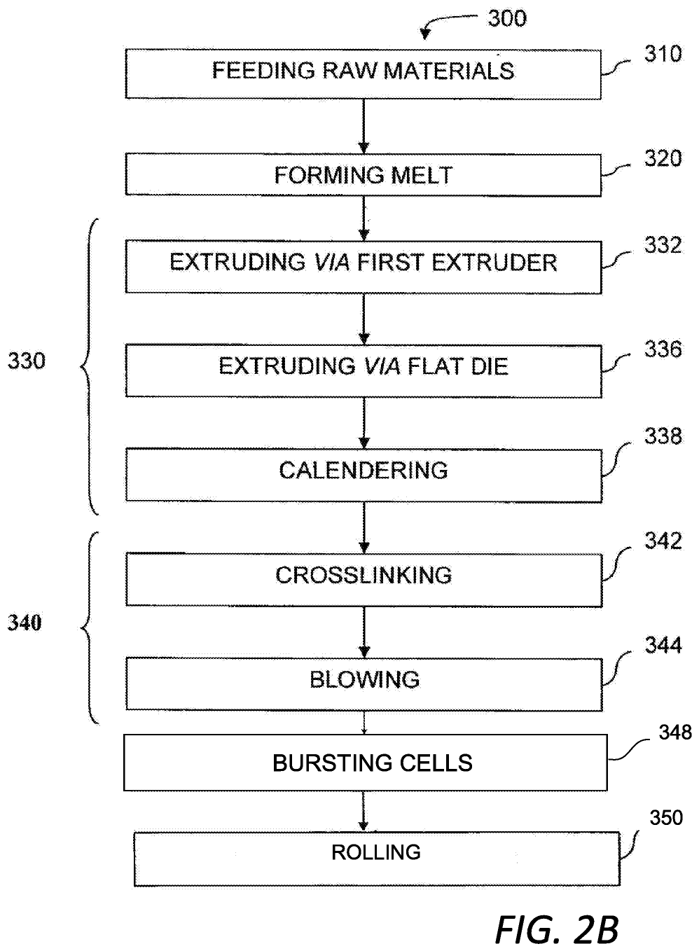

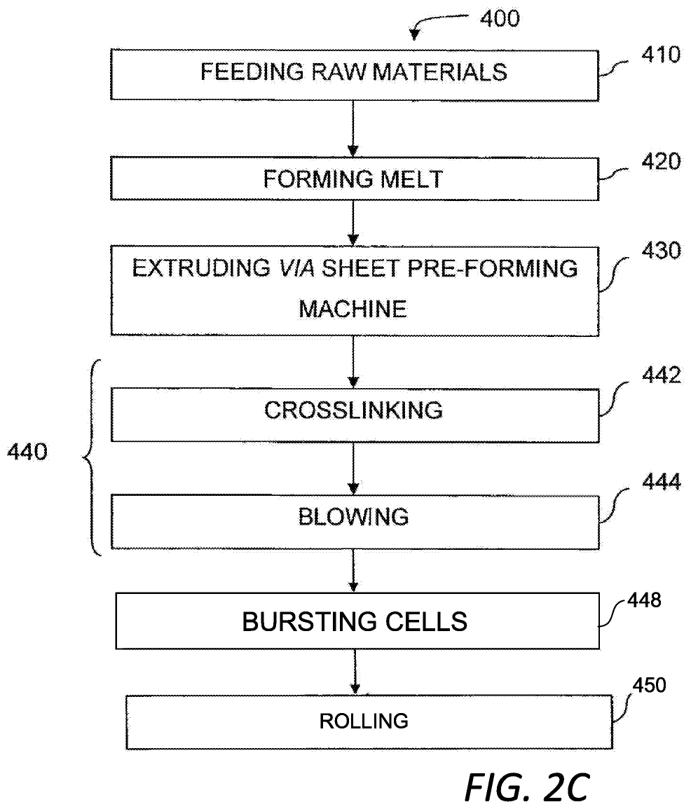

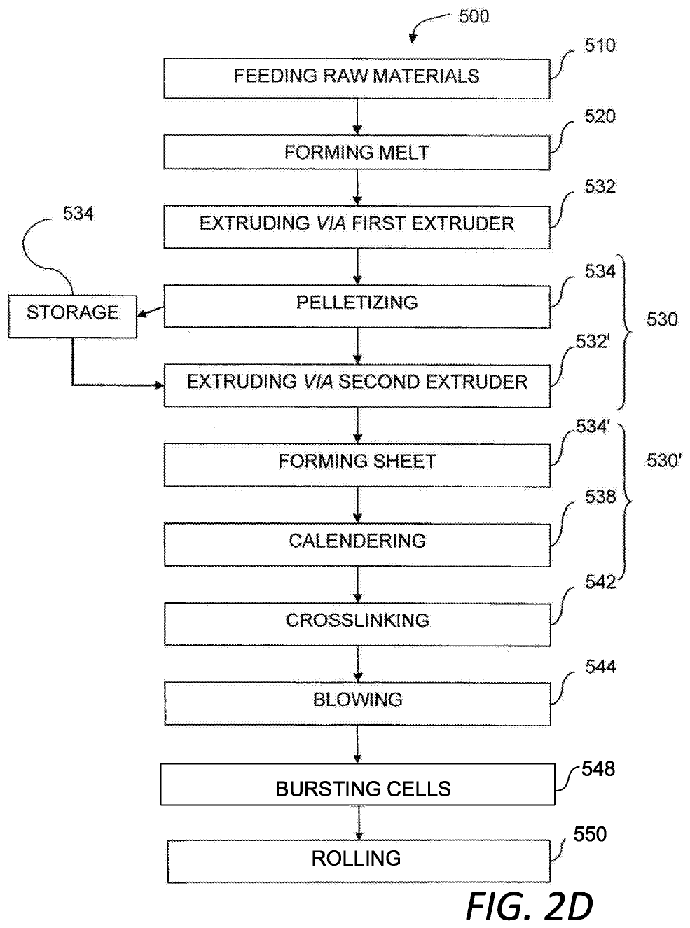

Reference is now made to FIGS. 2A-2D which are schematic illustrations of alternative steps for performing the process for producing a chemically cross-linked polyolefin based open cell foam. For simplicity, like reference numerals to those used in FIG. 1, shifted by 100 are used to identify steps having a similar function in FIGS. 2A-2D. For example, Step 120 in FIG. 1, which relates to the formation of a melt, is referred to as Step 220 in FIG. 2A, 320 in FIG. 2B, 420 in FIG. 2D and so forth.

Specifically, FIG. 2A illustrates a process 200 where firstly the mixture of raw materials comprising at minimum at least one polyolefin resin, a cross-linking agent, a blowing agent and rupturing agent is fed into a mixer (Step 210). The mixer may be any commercial mixer available in the industry, some examples of same provided hereinabove.

The mixer is also configured to convey heat at a temperature of between about 80° C. to about 150° C. (176-302° F.). Thus, while being continuously mixed, the raw materials melt (Step 220) while they are homogenized into a molten blend.

Once an essentially homogeneous melt is obtained and the temperature of the melt and the mixer inner chamber are essentially the same (although these criteria may vary, depending on the raw materials used), the melt is transferred (fed) into an extrusion line comprising a series of extruders in fluid communication. Accordingly, the homogeneous melt is firstly pressed into the inlet of a first extruder, being in this particular embodiment a tapered twin screw extruder (Step 232), is set to exert heat onto the melt received and contained therein at a temperature of between about 80° C. (176° F.) to about 200° C. (392° F.).

The molten blend is then extruded via the outlet of the tapered twin screw extruder directly into the inlet of a second extruder, in this particular embodiment, a single screw extruder (Step 234) the outlet of which is connected to the inlet of a flat die (Step 236). The molten blend extruded through the flat die is in the form of a continuous sheet.

The continuous sheet is then continuously fed into a multi-roll calender (Step 238) which can provide a predetermined sheet thickness. Two or more calendars can be used to smooth one or both surfaces of the sheet and/or provide sheets with a uniform, predetermined thickness.

The uniformly produced continuous sheet exiting the calendar is transferred to a conveyer oven (Step 240) having a first section (Step 242) which is set at a temperature sufficient for completing cross-linking of the polymers in the continuous sheet, and following in line, a second section (Step 244), which is set at a temperature sufficient for activating the blowing agent and blowing the received, chemically cross-linked polymeric sheet, to obtain the respective foamed sheet. The respective foamed sheet can be subjected to cooling using known methods in preparation for rupturing. The foamed sheet is then ruptured (Step 248) with the aid of the rupturing agent as described below. The sheet can then be cooled and processed for storage (Step 250). According to this embodiment, cooling is achieved on chiller rolls and the cooled continuous sheet is then wound on a core.

Reference is now made to FIG. 2B which illustrates a process 300, with essentially the same steps as illustrated in FIG. 2A, with the main difference that the process illustrated in FIG. 2B is missing in the respective Step 234, the use of a single screw extruder just after the tapered twin screw extruder. In other words, the essentially homogeneous melt existing the mixer is fed into an extrusion line comprising a tapered twin single extruder (Step 332), set to exert heat onto the molten received and contained therein at a temperature of between about 80° C. (176° F.) to about 200° C. (392° F.). The resulting blend is then directly fed into the inlet of a flat die (Step 336). Step 340 (e.g., comprising steps 338, 342), and step 348 and 350 are similar to that described above for FIG. 2A.

Reference is now made to FIG. 2C which illustrates a process 400, with essentially the same steps as illustrated in FIG. 2A, albeit with the difference that a sheet pre-forming machine is utilized in Step 430 to form a sheet of uniform thickness. Sheet pre-forming machines are well known in the art, and as an example, a sheet pre-forming machine as described by Moriyama Company Ltd. may be employed, with reference to the following website address: [http://www.ms-moriyama.co.jp/english/products/e_sheet_index.html]. The sheet pre-forming machine is comprised essentially of a tapered twin screw connected to mixer rolls. According to this particular embodiment, homogenized melt received from the mixer (from Step 420) is introduced initially into the tapered twin screw, set at a temperature of between about 80° C. (176° F.)-200° C. (392° F.), from which the melt is transferred into the mixer rolls to produce the polymeric sheet ready for heating (Step 440), rupturing (Step 448), and processing (Step 450).

Reference is now made to FIG. 2D which schematically illustrates a process 500 similar to the process of FIG. 2A, however, comprising an extrusion line which allows the formation of pellets from the homogenous melt. Specifically, following the formation of a melt comprising a homogeneous mixture of the raw materials (Steps 510, 520), the melt is extruded in a first extrusion line (Step 532) comprising a first extruder (Step 532), connected via its outlet to a pelletizing die allowing the formation of pellets comprising the homogenously mixed raw materials (Step 534). In this particular embodiment the first extrusion line comprises, respectively, a tapered twin single extruder (or into a combination in line of a tapered twin screw extruder followed by a single screw extruder) and “strands” forming die. The thus formed pellets may then be collected and stored (Step 560) for future return into the process (Step 570), or directly fed into a second extrusion line (Step 530′). In the second extrusion line, comprising a second extruder connected in line to a die, the pellets are received and thereby extruded to obtain thereby a sheet of uniform thickness (Steps 532′ and 534′). In this specific embodiment, the pellets are fed into a single or twin screw extruder (Step 532′) followed by extrusion via a flat die (Step 534′) for forming the sheet. The sheet is then further processed through a calendar and so forth, (Steps 538, 542, 544, 548, and 550) as detailed in connection with FIG. 2A, until the continuous open cell sheet of chemically cross-linked polymeric foam is obtained.

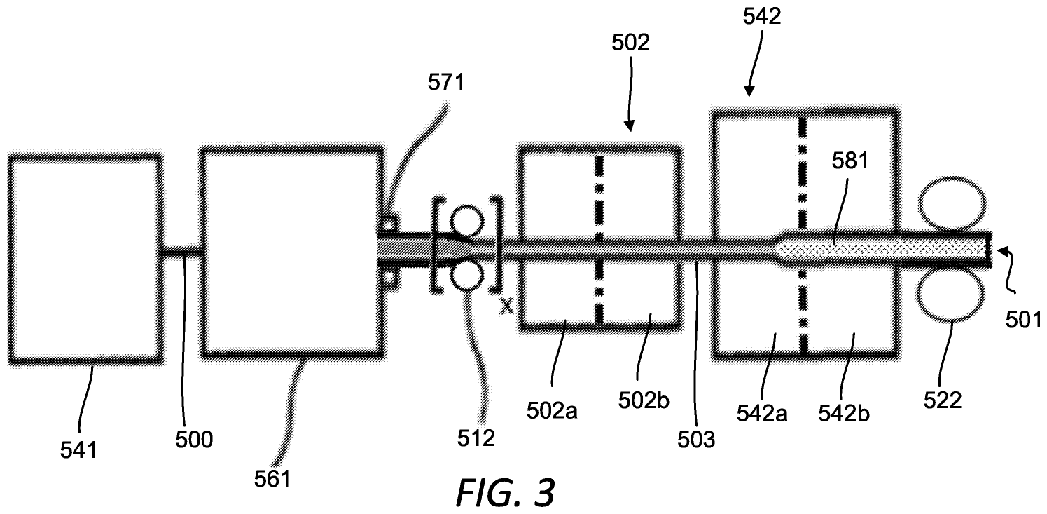

Reference is now made to FIG. 3 which shows an exemplary extrusion similar to that of FIG. 1, where material is added to mixer 541 to provide blended raw material 500 to extruder 561. FIG. 3 depicts an extruded sheet 503 that is a generally continuous planar, sheet, but other extruded shapes may be formed using the method of the present disclosure. The continuous sheet will typically have an uncured, un-foamed predetermined thickness that may range from about 1 millimeter to about 6 millimeter or thicker. Extruder 561 is shown with sheet die 571 for directly extruding the continuous sheet 503. Other dies can be used, e.g., for extruding a continuous sleeve having a uniform annular or vertical wall thickness. If a sleeve die is used, the continuous sheet may be formed by cutting through the sleeve wall immediately following the extrusion of the sleeve. Such an extruded form can then be flattened or slit to form a continuous sheet.

Continuous sheet 503 exiting die 571 is passed to two or more calender rolls 512 (where x=1-5) to reduce the thickness and/or width of extruded sheet 503. Reduced thickness extruded sheet 503 is then passed thru first section 502a and second section 502b of first heating module 502 for activation of the cross-linking agent. In one aspect, second section 502b is held at a higher temperature than first section 502a. In another aspect, second section 502b is held at the same or a lower temperature than first section 502a. Alternatively, an e-beam or other high energy source can be used. Alternatively, if silane-grafted polyolefin is used, promotion of cross-linking by introducing the silane and catalyst into the melt or at die 571.

Sheet 503 then exits second section 502b of first heating module 502 and enters first section 542a and second section 542b of second heating module 542. In one aspect, second heating module 542 has a higher temperature than first heating module 502. In another aspect, second heating module 542 has the same or lower temperature than first heating module 502. Foaming of the sheet occurs within first section 542a and second section 542 foamed sheet 581 of greater thickness than sheet 503 exits second oven 542. Chiller rolls 518 take up and cool sheet allowing sheet to at least partially set. In one aspect, prior to rupturing sheet 581, sheet 580 is cooled via chill rolls 522 that are used to reduce the temperature of the foamed sheet 581.

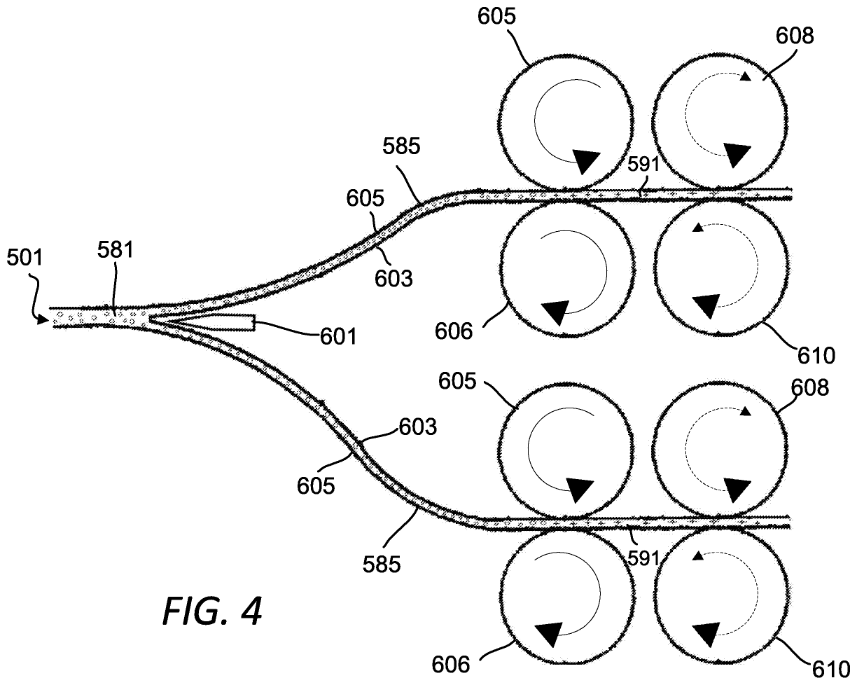

Reference is now made to FIG. 4, which represents a continuation of the continuous process depicted in FIG. 3 with the additional step of splitting the thickness of the skin-skin structured polymer sheet to form a pair of skin-cell structure sheets. In one example, the foam is fed through a horizontal blade and two (2) counter rotating rollers set at slightly below the foam thickness to form a pair of skin-cell structure sheets. Thus, horizontal edge 601 meets moving sheet 581 and provides two (2) sheets 585 by longitudinally slicing sheet 581. Sheets 585 have cell surface 603 and skin surface 605, where skin surface 605 is comprised of more closed cell density than cell surface 603 due to the cooling effect of the outer surface of sheet 581 during processing.

Sheets 585 are depicted as essentially the same thickness but can be of different thicknesses. Each of sheets 585 are taken up by rupturing rolls 505, 506 and subject to shear, compression, or combinations of shear and compression as well as other conditions suitable to rupture the closed cells and provide open cells. In one example, conditions suitable to rupture the closed cells provide 90-100% open cells from the closed cells. Rupturing rolls 505, 506, can be rotated in opposite directions as shown so as to provide a shear in addition to a compressive stress introduced by the nip gap between rupturing rolls 505, 506, which is adjusted to a spacing (nip gap) substantially less than the vertical thickness of sheets 585. Rollers 505, 506 are held in engagement with sheet 581 with sufficient pressure that closed cells present in the polymer sheet are ruptured to provide sheet 591 having open cells within the cured, foamed sheet. These shear/stresses can be repeated using a plurality of rollers in sequence, such as shown with additional rupturing rollers 608, 610. It should be understood that 3, 4, 5, 6, 7, 8, 9, 10 or more pairs of rupturing rollers can be employed. Rupturing rollers 608, 610 and/or any additional pairs of rupturing rollers can be configured identical to rupturing rolls 505, 506 or can be of different diameter, operated at a different speed and/or rotate in the same or different direction therefrom.

One or more rupturing rolls 505, 506, 608, 610 or any additional pairs of rupturing rollers can be configured for puncturing polymer sheet 585. In one example, rupturing rolls 505, 506 provide shear to polymer sheet 585 whereas rupturing rolls 608, 610 are configured for puncturing polymer sheet 585. Continuous open cell foam sheet 504 can then be taken up for storage.

Although the present disclosure has been described in conjunction with specific embodiments thereof, it is evident that many alternatives, modifications and variations will be apparent to those skilled in the art. The present disclosure will now be described with reference to the following non-limiting example.

### Cross-Linking and Foaming

The test mixtures of raw materials for formulas I and II were fed into a Banbury mixer heated to a temperature of about 140° C. (284° F.), thereby forming a molten blend of the raw materials. Via a hopper, the molten blend of the raw materials was fed into an extrusion line to produce a preliminary sheet that was thickness controlled via a three (3) roll calendar to form a continuous polymeric sheet of uniform thickness (e.g., 2 mm).

The continuous polymeric sheet was conveyed into a conveyer oven consisting of a first temperature section adapted to radiate heat at a temperature of 180° C. (356° F.) being the temperature for activating the dicumyl peroxide, for example followed by a second temperature section adapted to radiate heat at a temperature of 230° C. (446° F.) being the temperature for activating the azodicarbonamide, for example. As a result of this double stage heating of the sheet, a cross-linked polyethylene foam is obtained. The at least partially cross-linked, foamed sheet was then cooled after exiting the double stage oven to at least partially set the sheet and for allowing take up on a roll line.

Using one or more of the tested formulations possessing the desired properties, a 4 Kg quantity of formulation (polymer(s) plus all the other additives (cross-linking agent, blowing agent, rupturing agent, etc., were weighed out and loaded into a small industrial kneader with heating and mixing done at about 4-6 bar pressure and set points of between about 110° C. (230° F.) to about 140° C. (284° F.)(depending upon the polymer(s) used. The batch, once molten and homogeneous was transferred into the Hopper of the extruder and fed by a conical twin screw extruder into a single screw extruder. At the exit of extruder is a die that can be adjusted to change the thickness of the extrudate.

The molten sheet is calendared using at least a 3 roll Calendar unit where the thickness is more precisely controlled. From the exit of the Calendar the sheet was fed onto a conveyer belt for entering a first and second heating module, where the polymer sheet undergoes cross-linking and then foaming. A 4-zone dual heating module oven had both temperature and air flow control (from above and below). The cross-linking temperatures of the first 2 zones of the first heating module were 200° C.+/−20 (392° F.) and the foaming temperatures of the last 2 zones of the second heating module were 240° C.+/−25 (464° F.).

At the exit of the oven are chilling rolls and then a winder to collect the foamed roll.

### Bursting

Preliminary testing of the above formulations for bursting tests was performed on a pilot line roll mill: The rolls run at a fixed speed, but each one at a slightly different speed (so there is shearing). All bursting was performed on cold rupturing rolls. The gap was slowly narrowed and multiple passes thru the rupturing roll mill were performed and the product evaluated.

The rupturing rolls were controlled to adjust the shear rate using precision gap opening control +/−2 micron). Additional testing was performed on foam sheets run through the rolls at different speeds, at different shear rates and at different gap openings multiple times and in multiple directions using various formulations described herein.

Lab Testing of the resultant continuous open cell foamed sheet included density, tensile strength, elongation, and compression strength. Additional testing was performed on certain samples including: tear strength, shore hardness, dimensional stability (at a defined temperature), compression set, open cell content (by gas pynometry), tortuosity, scanning electron microscope (SEM) in order to analyze cell size and to examine the nature of the rupturing in the cell walls, and acoustic testing (according to ISO 10534-2).

An in-house oil absorption test was performed using 10 cm×10 cm×1 cm (or as close as possible to 10 mm thick) pieces of foam samples placed in, for example, Mobil Motor Oil—5W-30 oil for 1 hr and then removed and weighed to determine weight of oil absorbed. Additional absorption tests using Diesel oil and highly viscous Fuel Oil were conducted. In addition, oil absorption testing was performed under the CEDRE protocol (20 minutes in contact with Arabian Crude oil with gentle mixing, and 30 minutes of dripping followed by both a gravimetric measurement of how much oil was absorbed as well as an analytical method that including a filtration and spectroscopy.

Tables 1 and 2 summarize exemplary formulations comprising base polymers of polyolefin or polyolefin blends with various rupturing agents, levels of peroxide cross-linking agent/blowing agent, and subsequent bursting parameters (nip gap (mm) and number of passes of the sheet through the nip gap (#Passes) were prepared and the samples were tested for absorption. LDPEs tested included different melt flow indexes (MFI). Polyolefin blends tested included LDPE with ethylene vinyl acetate EVA (including differing amounts of VA %), ethylene butyl acetate (EBA), ethylene methyl acrylate (EMA), metallocene plastomer (ENGAGE™ and EXACT™) and mixtures thereof.

Some samples were absorption tested, without a skin surface (cell-cell), while most samples had a skin-cell structure. Bursting/crushing of the closed cells were performed under different crushing and shear conditions and examined using scanning electron microscopy (SEM). Multiple grades of inorganic powers of varying particle sizes were tested to evaluate rupturing performance and absorption performance for various base polymers. Multiple grades of organic polymer powders of varying particle sizes were tested to evaluate rupturing performance and absorption performance for various base polymers. Controls included commercially available material OPFLEX™ (AquaFlex, Boston, Mass.) with absorbance of 27.2 times its weight for oil absorption.

In the samples tested, the amount of DCP (Peroxide) was adjusted in order to reduce or increase the amounts of cross-linking in combination with rupturing agent and bursting parameters in the final foam so as to investigate the resultant absorption properties obtained for different base polymers. In the samples tested, 20-25 PHR of blowing agent (ADCA) was used.

Burst/Shear of the samples was performed with single or multi pairs of rolls, where each pass thru a roll pair of nip gap constituted a “pass” for determining the number of passes (#Passes). If no passes thru nip rollers were performed, the #Passes is stated as 0.

Absorption data for exemplary formulations of polyolefins at least partially cross-linked, foamed and burst in a continuous process as described here are presented in Table 1. As shown in Table 1, the presently presented LDPE formulations obtained absorption values similar to that of commercial products that are either block processed and/or contain polyolefin blends with acrylate polymers.

Absorption data for exemplary formulations of polyolefin blends at least partially cross-linked, foamed and burst in a continuous process as described here are presented in Table 2. As shown in Table 2, the presently presented polyolefin blend formulations obtained absorption values similar to that of commercial products that are block processed.

Thus, the present formulations and method provide for the continuous production of at least partially cross-linked, open cell foam, useful for, among other things, oil absorption slow release gaskets, ultra-soft gaskets and acoustic absorbers.

While certain embodiments of the present disclosure have been illustrated with reference to specific combinations of elements, various other combinations may also be provided without departing from the teachings of the present disclosure. Thus, the present disclosure should not be construed as being limited to the particular exemplary embodiments described herein and illustrated in the Figures, but may also encompass combinations of elements of the various illustrated embodiments and aspects thereof.

TABLE 1
Absorption data of polyolefin and polyolefin copolymer
cross-linked, continuous open foam examples

| | | | | gap | | Absorption |
|---|---|---|---|---|---|---|
| | | Peroxide | Rupturing | width | | (x original |
| Sample | | (wt. %) | Agent | (micron) | #Passes | wt.) |
| 934 | LDPE | 0.45 | inorganic | 750 | 4 | 13.5 |
| 934 | | | | 750 | 8 | 11.9 |
| 934 | | | | 1000 | 4 | 10.0 |
| 934 | | | | 1500 | 8 | 15.4 |
| 934 | | | | 3000 | 4 | 6.4 |
| 934 | | | | 0 | 0 | 4.2 |
| 929 | LDPE | 0.50 | inorganic | 750 | 8 | 13.6 |
| 929 | | | | 1000 | 8 | 13.5 |
| 930 | LDPE | 0.55 | inorganic | 1000 | 8 | 13.0 |
| 930 | | | | 1500 | 8 | 9.5 |
| 923 | LDPE | 0.60 | inorganic | 750 | 8 | 14.8 |
| 923 | | | | 750 | 8 | 14.5 |
| 923 | | | | 750 | 4 | 12.7 |
| 923 | | | | 1000 | 8 | 13.9 |
| 923 | | | | 1000 | 8 | 13.2 |
| 923 | | | | 0 | 0 | 13.2 |
| 924 | LDPE | 0.70 | inorganic | 500 | 8 | 13.8 |
| 924 | | | | 500 | 4 | 12.4 |
| 924 | | | | 750 | 8 | 14.1 |
| 924 | | | | 750 | 8 | 11.7 |
| 924 | | | | 1000 | 8 | 13.7 |
| 924 | | | | 1500 | 8 | 10.6 |
| 911 | 50% LDPE/50% | 0.8 | inorganic | 500 | 4 | 14.0 |
| | metallocene | | | | | |
| 928A | 90% LDPE/10% | 0.7 | inorganic | 750 | 8 | 14.9 |
| | metallocene | | | | | |

TABLE 2
Absorption data of polyolefin-blends, cross-linked, continuous open foam examples.

| | | | | gap | | Absorption |
|---|---|---|---|---|---|---|
| | Polymer Blend | Peroxide | Rupturing | width | | (x original |
| Sample | (wt. %) | (wt. %) | Agent | (micron) | #Passes | wt.) |
| 926 | 20% LDPE - 80% EVA | 0.7 | inorganic | 1000 | 2 | 10.2 |
| 926 | | | | 2500 | 4 | 13.9 |
| 926 | | | | 4000 | 8 | 13.5 |
| 926 | | | | 4000 | 4 | 10.8 |
| 925 | 20% LDPE - 80% EVA | 0.85 | organic | 2500 | 4 | 12.1 |
| 925 | | | | 4000 | 8 | 12.2 |
| 925 | | | | 4000 | 4 | 11.7 |
| 925 | | | | 0 | 0 | 5.2 |
| 906 | 50% LDPE - 50% EVA | 0.8 | inorganic | 500 | 8 | 17.2 |
| 906 | | 0.7 | | 500 | 4 | 15.9 |
| 906 | | 0.8 (+5% | | 0 | 0 | 8.3 |
| | | antistatic) | | | | |
| 916 | | 0.8 | | 0 | 0 | 10.0* |
| 927 | 50% LDPE - 50% EVA | 0.6 | inorganic | 750 | 8 | 21.5 |
| 927 | | | | 1000 | 8 | 18.9 |
| 927 | | | | 1500 | 8 | 18.0 |
| 927 | | | | 2500 | 4 | 14.1 |
| 931 | 50% LDPE - 50% EVA | 0.6 | inorganic | 750 | 8 | 16.5 |
| 931 | | | | 750 | 4 | 11.6 |
| 931 | | | | 1000 | 4 | 11.5 |
| 931 | | | | 1500 | 8 | 14.3 |
| 931 | | | | 3000 | 4 | 14.7 |
| 931 | | | | 0 | 0 | 4.2 |
| 932 | 80% LDPE - 20% EVA | 0.6 | inorganic | 750 | 8 | 17.7 |
| 932 | | | | 750 | 4 | 16.5 |
| 932 | | | | 1500 | 8 | 15.3 |
| 932 | | | | 1000 | 4 | 14.5 |
| 932 | | | | 3000 | 4 | 11.3 |
| 932 | | | | 0 | 0 | 4.6 |
| 933 | 80% LDPE - 20% EVA | 0.85 | organic | 750 | 8 | 22.9 |
| 933 | | | | 750 | 4 | 16.2 |
| 933 | | | | 1000 | 4 | 18.2 |
| 933 | | | | 1500 | 8 | 18.5 |
| 933 | | | | 3000 | 4 | 12.5 |
| 933 | | | | 0 | 0 | 4.6 |

*Cell-Cell structure sample.

We claim:

1. A method of continuously forming an open cell foam sheet comprising:
heating and admixing at least one thermoplastic olefin polymer, at least one foaming agent, and at least one rupturing agent for a period of time sufficient to form a melt suitable for forming a polymer sheet;
continuously engaging the polymer sheet under conditions sufficient to at least partially cross-link the polymer sheet so as to provide at least partially cross-linked polymer sheet;
continuously engaging the at least partially cross-linked polymer sheet under conditions sufficient to partially decompose the at least one foaming agent and to at least partially foam the partially cross-linked polymer sheet so as to provide an at least partially cross-linked foamed polymer sheet having substantially closed cells; and
continuously engaging the at least partially cross-linked foamed polymer sheet through a nip of at least one pair of rollers under conditions sufficient to rupture the closed cells.

2. The method of claim 1, wherein the at least one thermoplastic olefin polymer is polyethylene or a polyethylene copolymer.

3. The method of claim 1, wherein the at least one thermoplastic olefin polymer is a mixture of polyethylene or polyethylene copolymer and ethylene vinyl acetate.

4. The method of claim 1, wherein the at least one rupturing agent is selected from polymer powder having a melting point higher than the at least one thermoplastic olefin polymer, the rupturing agent present in an amount of between about 10 PHR-50 PHR.

5. The method of claim 1, wherein the at least one rupturing agent is calcium carbonate or barium sulfate present in an amount of between about 10 PHR-50 PHR.

6. The method of claim 1, wherein the conditions sufficient to at least partially cross-link the polymer sheet include chemical cross-linking or physical cross-linking.

7. A method to selectively absorb liquid hydrocarbons from a mixture of liquid hydrocarbons and water or land, the method comprising:
contacting a mixture of liquid hydrocarbons and water or land with an open-cell foam composition comprising a reaction product of:
i) at least one thermoplastic olefin polymer selected from polyethylene or polyethylene copolymer, ethylene-alkyl acrylate copolymer, or a mixture thereof;
ii) a chemical foaming agent;
iii) chemical cross-linking agent or physical cross-linking; and
iv) at least one rupturing agent;
wherein the open-cell foam composition has an absorption weight capacity of hydrocarbon oil of at least about 10 times the weight of the open-cell foam composition.

8. The method of claim 7, wherein the at least one rupturing agent is selected from polymer powder having a melting point higher than the at least one thermoplastic olefin polymer present in an amount of between about 10 PHR-50 PHR.

9. The method of claim 7, wherein the at least one rupturing agent is calcium carbonate or barium sulfate present in an amount of between about 10 PHR-50 PHR.

10. An open cell foam sheet comprising:
a reaction product of:
i) polyethylene, polyethylene copolymer, or a mixture thereof;
ii) a chemical foaming agent; and
iii) a chemical cross-linking agent or physical cross-linking;
the reaction product comprising an amount of at least one rupturing agent present in an amount of between about 10 PHR-50 PHR capable of facilitating at least 90% closed cell rupturing of the reaction product when subject to compression and/or shear to provide an open-cell foam;
wherein the open-cell foam comprises an average open cell size greater than 0.02 inches (0.5 mm) and less than 0.1 inches (2.5 mm);
a density of between about 1.0 and about 3.0 pounds per cubic foot (16 Kg/m³-48 Kg/m³); and
an absorption weight capacity of hydrocarbon oil of at least about 10 times the weight of the open-cell foam sheet.

11. The sheet of claim 10, wherein the polyethylene, polyethylene copolymer, or a mixture thereof comprises a linear low density polyethylene and copolymer of ethylene and an alpha-olefin selected from one or more of iso-propene, butene, iso-pentene, hexane, iso-heptene, and octane.

12. The sheet of claim 10, wherein the at least one rupturing agent is selected from polymer powder having a melting point higher than the polyethylene, polyethylene copolymer, or a mixture thereof.

13. The sheet of claim 10, wherein the at least one rupturing agent is calcium carbonate or barium sulfate present in an amount of between about 10 PHR-50 PHR.

14. An open cell foam sheet comprising:
a reaction product of:
i) ethylene-alkyl acrylate copolymer;
ii) a chemical foaming agent; and
iii) a chemical cross-linking agent or physical cross-linking;
the reaction product comprising an amount of at least one rupturing agent present in an amount of between about 10 PHR-50 PHR capable of facilitating at least 90% closed cell rupturing of the reaction product when subject to compression and/or shear to provide an open-cell foam;
wherein the open-cell foam comprises an average open cell size greater than 0.02 inches (0.5 mm) and less than 0.1 inches (2.5 mm);
a density of between about 1.0 and about 3.0 pounds per cubic foot (16 Kg/m³-48 Kg/m³); and
an absorption weight capacity of hydrocarbon oil of at least about 10 times the weight of the open-cell foam composition.

15. The sheet of claim 14, wherein the ethylene-alkyl acrylate copolymer comprises 20-80 wt. % alkyl acrylate, wherein the alkyl acrylate is selected from one or more of methyl acrylate, ethyl acrylate, and butyl acrylate.

16. The sheet of claim 14, wherein the at least one rupturing agent is selected from polymer powder having a melting point higher than the ethylene-alkyl acrylate copolymer.

17. The sheet of claim 14, wherein the at least one rupturing agent is calcium carbonate or barium sulfate present in an amount of between about 10 PHR-50 PHR.
